(19) United States
(12) Patent Application Publication
(10) Pub. No.: US 2024/0073210 A1
(43) Pub. Date: Feb. 29, 2024

(54) CONTROL METHOD AND DEVICE AND ELECTRONIC DEVICE

(71) Applicant: Lenovo (Beijing) Limited, Beijing (CN)

(72) Inventors: Yanfeng KUANG, Beijing (CN); Zhiping LI, Beijing (CN)

(21) Appl. No.: 18/233,752

(22) Filed: Aug. 14, 2023

(30) Foreign Application Priority Data
Aug. 31, 2022 (CN) 202211059169.5

(51) Int. Cl. H04L 9/40; G06F 1/28

(52) U.S. Cl. CPC H04L 63/0876; G06F 1/28

(57) ABSTRACT

A control method that is applied to a first electronic device, the method including in response to obtaining a trigger signal, determining a target component corresponding to the trigger signal; and sharing the target component with a second electronic device to expand performance of the second electronic device corresponding to the target component, the second electronic device being a device that establishes a target connection with the first electronic device, when the first electronic device is in different power mode, sharing method of the target component is different.

### CROSS-REFERENCES TO RELATED APPLICATION

This application claims priority to Chinese Patent Application No. 202211059169.5 filed on Aug. 31, 2022, the entire content of which is incorporated herein by reference.

### FIELD OF TECHNOLOGY

The present disclosure relates to the field of computer control technology and, more specifically, to a control method and device, and an electronic device.

### BACKGROUND

At present, due to its portability, notebook computers have gradually become the preferred device for users at work. When using notebook computer for work, due to the limited target performance of the notebook computer, when the target data is processed, the user's work efficiency will be affected. In related technologies, the user can manually copy the target data on the notebook computer to a target device with relatively high target performance, process the target data through the target device, and then manually copy the processed target data from the target device to the notebook computer. However, this method processing target data has high operational complexity.

### SUMMARY

The present disclosure provides a control method. The control method that can be applied to a first electronic device. The control method includes in response to obtaining a trigger signal, determining a target component corresponding to the trigger signal; and sharing the target component with a second electronic device to expand performance of the second electronic device corresponding to the target component, the second electronic device being a device that establishes a target connection with the first electronic device. When the first electronic device is in different power mode, sharing method of the target component is different.

The present disclosure further provides a control device. The control device includes a determining unit and a processing unit. The determining unit is configured to, in response to obtaining a trigger signal, determine a target component corresponding to the trigger signal. The processing unit is configured to share the target component with a second electronic device to expand performance of the second electronic device corresponding to the target component, the second electronic device being a device for establishing a target connection with the control device. When the control electronic device is in different power mode, sharing method of the target component is different.

The present disclosure further provides an electronic device. The electronic device is used as a first electronic device. The electronic device includes a target component, a switch component, a target interface, and a target controller. The target component is configured to provide a target function. A third end of the switch component being connected to the target component. The target interface is configured to establish a target connection with a second electronic device. An output end of the target controller is connected to a first end of the switch component. The target controller is configured to control a second end of the switch component to be connected to the target interface, and to control a path between the switch component and the target interface to share the target component with the second electronic device to expand performance of the target component corresponding to the second electronic device.

### BRIEF DESCRIPTION OF THE DRAWINGS

FIG. 1 is a flowchart of a control method according to an embodiment of the present disclosure.

FIG. 2 is a flowchart of another control method according to an embodiment of the present disclosure.

FIG. 3 is a flowchart of another control method according to an embodiment of the present disclosure.

FIG. 4 is a schematic diagram of a target display interface of the control method provided by an embodiment of the present disclosure.

FIG. 5 is a flowchart of a second electronic device sharing a target component in different power modes in the control method provided by an embodiment of the present disclosure.

FIG. 6 is a schematic structural diagram of a control device according to an embodiment of the present disclosure.

FIG. 7 is a schematic structural diagram of an electronic device according to an embodiment of the present disclosure.

FIG. 8 is a schematic structural diagram of another electronic device according to an embodiment of the present disclosure.

FIG. 9 is a schematic structural diagram of another electronic device according to an embodiment of the present disclosure.

### DETAILED DESCRIPTION

Hereinafter, aspects, features, and embodiments of the present disclosure will be described with reference to the accompanying drawings. Such description is illustrative only but is not intended to limit the scope of the present disclosure. In addition, it will be understood by those skilled in the art that various modifications in form and details may be made therein without departing from the spirit and scope of the present disclosure.

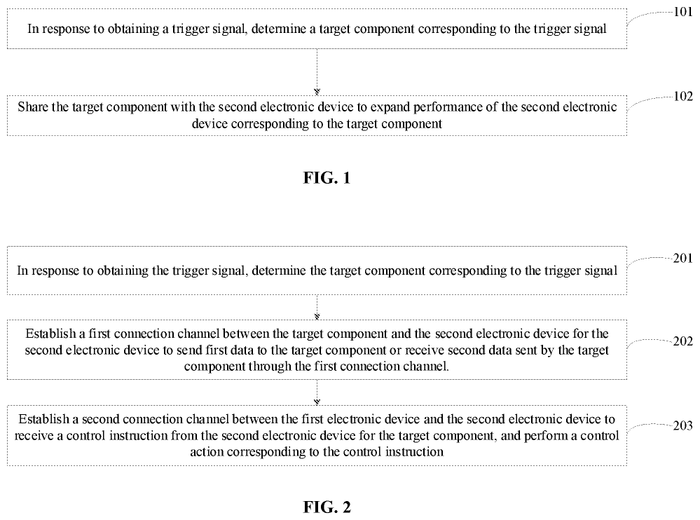

Embodiments of the present disclosure provides a control method, which can be applied to a first electronic device. FIG. 1 is a flowchart of a control method according to an embodiment of the present disclosure. The method will be described in detail below.

101, in response to obtaining a trigger signal, determining a target component corresponding to the trigger signal.

In the embodiments of the present disclosure, the first electronic device may be a device with data processing functions. The trigger signal may be generated by the first electronic device in response to the user's input operation, or generated by the second electronic device in response to the user's input operation and sent to the first electronic device. In addition, the trigger signal may also be generated by the second electronic device based on its own operating state information. Of course, the trigger signal may also be generated when the first electronic device and the second electronic device are connected through a target interface. In some embodiments, the first electronic device and the second electronic device may be the same device or different devices.

In some embodiments, the first electronic device may be an all-in-one (AIO) computer, a desktop computer, a notebook computer, a TV, a projector, a conference machine, and a display. Of course, other devices can also be used as the first electronic device, which is not limited in the embodiments of the present disclosure.

In the embodiments of the present disclosure, a plurality of components on the first electronic device may be screened to obtain a target component in response to the trigger signal. In some embodiments, the target component may at least include a processor, a memory, and a sensor. The processor may include at least one of a graphics processing unit (GPU), a video processing unit (VPU), a digital-signal-processing unit (DSP), and an image signal processor (ISP). The memory may include at least one of a solid-state disk (SSD) and a hard disk drive (HDD). The sensor may include at least one of a camera, a microphone, and a speaker.

In some embodiments, the operating state information of each component on the first electronic device may be obtained in response to the trigger signal, and the target operating state that satisfies a target operating state condition may be determined from a plurality of operating state information, and the component corresponding to the target operating state information may be used as the target component.

In some embodiments, when the trigger signal carries first identification information capable of pointing to the target component, the component corresponding to the first identification information may be determined as the target component from the plurality of components of the first electronic device.

102, providing the target component to the second electronic device for use to expand performance of the second electronic device corresponding to the target component.

In some embodiments, the first electronic device may be a device that establishes a target connection with the first electronic device. When the first electronic device is in different power modes, the sharing methods of the target component may be different.

In the embodiments of the present disclosure the first electronic device may establish a target channel for sharing the target component to the second electronic device, such that the second electronic device can sue the target component to process data through the target channel, thereby expanding the performance of the target component on the second electronic device.

In some embodiments, the first electronic device may be an AIO machine, the target component may be a GPU on the AIO machine, and the second electronic device may be a notebook computer. The AIO machine may establish a target channel for sharing its own GPU to the notebook computer. The notebook computer may transmit the to-be-processed image to the GPU of the AIO machine through the target channel, and process the image to-be-processed image through the GPU of the AIO machine to increase the rendering performance of the notebook computer. In some cases, the rendering performance of the GPU on the AIO may be better than the rendering performance of the GPU on the notebook computer.

In the embodiments of the present disclosure, the second electronic device may initiate a connection request to the first electronic device, and after receiving the connection request, the first electronic device may establish a target connection between the first electronic device and the second electronic device. In some embodiments, the connection request may be initiated by the second electronic device to the first electronic device based on its own operating state information or based on the operating state information of the target component on the second electronic device. Of course, the connection request may also be initiated by the second electronic device to the first electronic device in response to a user's connection operation. In addition, the first electronic device may also actively establish a target connection with the second electronic device.

More specifically, a wired target connection may be established between the first electronic device and the second electronic device through the target interface. Of course, a wireless target connection may also be established between the first electronic device and the second electronic device in a wireless manner.

In some embodiments, a target connection may be established between the first electronic device and the second electronic device through a Thunderbolt interface. More specifically, a Thunderbolt cable may be respectively connected to the Thunderbolt interface on the first electronic device and the Thunderbolt interface on the second electronic device. In some embodiments, the target interface may include a Thunderbolt interface, and the Thunderbolt interface may be referred to as Thunderbolt or TBT interface.

In some embodiments, a screen projection connection may be established between the first electronic device and the second electronic device in a wireless manner. A wireless fidelity (Wi-Fi) direct connection may also be established between the first electronic device and the second electronic device in a wireless manner. Of course, the first electronic device and the second electronic device may also perform an Internet Protocol (IP) Address direct connection in a wireless manner.

In the embodiments of the present disclosure, the current power mode of the first electronic device may be determined. The corresponding sharing method may be selected based on the power mode, and the target component may be shared with the second electronic device based on the selected sharing method. In some embodiments, the sharing method may include different sharing paths and/or sharing logics.

In some embodiments, the power mode may include the G3 mode, S0 mode, S1 mode, S2 mode, S3 mode, S4 mode, and S5 mode. The G3 mode may refer to the mode in which the first electronic device is powered off. S0 mode may refer to the normal operation of the first electronic device, and all components on the first electronic device may be in the turned-on or normal working state. The S1 mode is also known as the most power-consuming sleep mode. The S1 mode may refer to the mode in which the central processing unit (CPU) stops working, but other components still work normally, and the power of the CPU is not turned off. The S2 mode may refer to the mode in which the CPU stops working, but other components still work normally, and the CPU power is turned off. The S3 mode may refer to the mode in which the hard disk is turned off after writing the running data into the memory. The S4 mode may refer to the mode in which memory information is written into the hard disk, and then all components stop working. The S5 mode may refer to the mode in which the first electronic device is turned off.

Consistent with the present disclosure, the control method may include determining the target component corresponding to the trigger signal in response to the obtained trigger signal, and sharing the target component with the second electronic device to expand the performance of the second electronic device corresponding to the target component, the second electronic device being a device that establishes a target connection with the first electronic device. In some embodiments, when the first electronic device is in different power modes, the target component may be shared in different ways. In this way, in response to the obtained trigger signal, the first electronic device can automatically use the determined target component corresponding to the trigger signal the second electronic device to expand the performance of the target component corresponding to the second electronic device. For example, the second electronic device may use the target component on the first electronic device to process the target data without requiring the user to manually copy the target data on the second electronic device to the first electronic device. After the first electronic device processes the target data, processed target data does not need to be manually copied to the second electronic device, which reduces the operational complexity of processing the target data, thereby improving the processing of the target data.

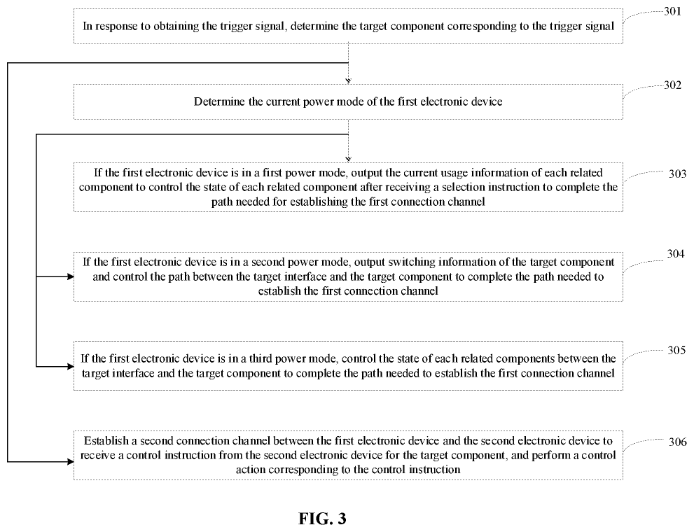

FIG. 2 is a flowchart of another control method according to an embodiment of the present disclosure. The control method can be applied to the first electronic device. The method will be described in detail below.

201, in response to obtaining the trigger signal, determining the target component corresponding to the trigger signal.

In some embodiments, the determination of the target component corresponding to the trigger signal in the process at 201 may be achieved through processes A1-A5 below.

A1: if the trigger signal carries the first identification information that can point to the target component, determine the component that matches the first identification information among the components that can be shared by the first electronic device as the target component.

In the embodiments of the present disclosure, the obtained trigger signal may be detected. If it is detected that the trigger signal carries the first identification information, based on the first identification information, the component corresponding to the first identification information may be determined as the target component from the components for sharing provided by the first electronic device. In some embodiments, the trigger signal may be generate based on a user's input operation.

A2: determine the power mode of the first electronic device, and determine the target component from the components of the first electronic device currently can share based on the power mode.

In the embodiments of the present disclosure, the first electronic device may detect the power mode it is currently in, and determine the component corresponding to the power mode as the target component from the components that the first electronic device can currently share. In some embodiments, different components may correspond to different power modes. Of course, the operation state information of the first electronic device in the power state may also be determined, and the target component may be determined from the components that the first electronic device can currently share based on the operating state information of the first electronic device.

In some embodiments, when the first electronic device is in the S5 mode, the component corresponding to the S5 mode may be a GPU or a hard disk.

A3: determine the power mode of the first electronic device and the component usage paraments of each component of the first electronic device in the power mode, and determine the target component based on the power mode and the component usage parameters.

In some embodiments, the component usage parameters may characterize the usage of the component in the power mode.

In the embodiments of the present disclosure, the components corresponding to the power mode of the first electronic device may be determined from the components that the first electronic device can currently share as the candidate components, and the component usage parameters of the candidate components in the power mode may be determined. Subsequently, the component whose usage parameters meet the usage parameters of the target component may be determined as the target component from the candidate components.

A4: obtaining second identification information of the second electronic device, and determine the component in the first electronic device that matches the second identification information as the target component.

In some embodiments, the second identification information may be carried in the trigger signal. Of course, the first electronic device may also send an acquisition instruction for obtaining the second identification information to the second electronic device, and the second electronic device may send the second identification information to the first electronic device based on the acquisition instruction after receiving the acquisition instruction. In some embodiments, the second identification information may be used to uniquely refer to the second electronic device.

In the embodiments of the present disclosure, the first electronic device may determine the component corresponding to the second identification information from the components that the first electronic device can currently share based on the second identification information. In some embodiments, when different second electronic devices connected to the first electronic device, the determined target component may be different. Further, the second electronic device may be a device that has previously shared the components of the first electronic device. In some embodiments, the first electronic device may store the target correspondence between the identifier characterizing each second electronic device and the components that the second electronic device can share.

In some embodiments, the second electronic device may have shared the hard disk of the first electronic device before, and the first electronic device may establish a target correspondence between the second identification information of the second electronic device and the hard disk. When the second electronic device connects to the first electronic device again, the first electronic device may share the hard disk as the target component with the second electronic device based on the second identification information of the second electronic device and the target correspondence.

A5: obtain the generation time of the trigger signal, and determine the component in the first electronic device that matches the generation time as the target component.

In some embodiments, the usage time of each component of the first electronic device may be stored.

In the embodiments of the present disclosure, the generation time of the trigger signal may be recorded by the first electronic device itself, or the generation time of the trigger signal may be sent to the first electronic device by the second electronic device. The generation time of the trigger signal may be matched with the usage time of each component on the first electronic device. The target usage time that matches the generation time of the trigger signal may be determined, and the component corresponding to the target usage time may be used as the target component.

In some embodiments, when the generation time of the trigger signal is 9:00˜18:00, the display screen and/or speaker may be used as the target component; when the generation time of the trigger signal is 19:00˜24:00, the hard disk of the first electronic may be used as the target component.

In addition, first position information of the second electronic device may also be obtained when the trigger signal is generated, and the component in the first electronic device that matches the first position information may be used as the target component. Further, second position information of the second electronic device may also be obtained when the trigger signal is generated, and the component in the first electronic device that matches the second position information may be used as the target component. Of course, based on the determined position information of the first electronic device and the position information of the second electronic device when the trigger signal is generated, a target distance between the first electronic device and the second electronic device may be determined, and the component corresponding to the target distance in the first electronic device may be determined as the target component.

It should be noted that the trigger signal in the process at 201 may be generated in at least one of the following methods.

In the first method, the trigger signal may be generated by an input operation acting on the first electronic device.

In some embodiments, the input operation may include at least one of voice input, gesture input, trigger button input, mouse input, and touch input. Of course, the input operation may also be other operations input by the user, which is not limited in the embodiments of the present disclosure.

In some embodiments, the user may perform an input operation on the first electronic device, and after receiving the user's input operation, the first electronic device may generate a trigger signal based on the input operation.

In some embodiments, the first electronic device may generate a trigger signal based on the received user touch input operation on a target area on the display interface. In other embodiments, the first electronic device may include a mode button, and the user may perform a press operation on the mode button. The first electronic device may generate a trigger signal based on the press operation.

It should be noted that, in the embodiments of the present disclosure, the input operation may also be the user's selection operation for the components that can be shared by the first electronic device. The first electronic device may generate a trigger signal carrying the first identification information of the target component based on the selection operation, and then the target component corresponding to the first identification information may be determined from components that the first electronic device can share.

In some embodiments, when the selection operation is voice input, the first identification information may be audio information; when the selection operation is a character input sting, the first identification information may be a specific character string.

In the second method, the trigger signal may be generated by an input operation acting on the second electronic device.

In the embodiments of the present disclosure, the user may perform an input operation on the second electronic device, and after receiving the user's input operation, the second electronic device may generate a trigger signal based on the input operation, and send the trigger signal to the first electronic device.

It should be noted that, when the input operation in the second method is a selection operation, a trigger signal may be generated based on the selection operation, and the target component corresponding to the trigger signal may be determined. This process the same as the process of determining the target component in the first method, which will not be repeated here.

In the third method, the trigger signal may be generated based on the second electronic device establishing the target connection with the first electronic device.

In the embodiments of the present disclosure, the trigger signal may be generated when the second electronic device establishes a target connection with the first electronic device, or the trigger signal may be generated when the second electronic device successfully establishes a target connection with the first electronic device. In some embodiments, the target connection may include a projection screen connection and a redundant array of independent disk (Raid) connection.

In some embodiments, the trigger signal may be generated when the second electronic device establishes a screen projection connection with the first electronic device.

some embodiments, the trigger signal may be generated when the second electronic device establishes a Raid connection with the first electronic device.

In the fourth method, the trigger signal may be generated based on a target application running on the second electronic device.

In some embodiments, the target application may include at least one of audio applications, image acquisition applications, gaming applications, data migration applications, and data synchronization applications. Of course, the target application may also be other types of applications, which is not limited in the embodiments of the present disclosure.

In the embodiments of the present disclosure, the target application may be an application currently running on the second electronic device; the target application may be a preset application; the target application may be an application selected by the second electronic device from the currently running applications; or an application selected by the user from the currently running applications. When running the target application, the second electronic device may automatically generate a trigger signal and the trigger signal to the first electronic device. Alternatively, a trigger signal may be generated when the first electronic device detects that the target application is running on the second electronic device.

In the fifth method, the trigger signal may be generated based on at least hardware configuration information of the second electronic device.

In the embodiments of the present disclosure the first electronic device or the second electronic device may analyze the hardware configuration information of the second electronic device, and generate a trigger signal when the target performance of the second electronic device is poor based on the analysis results. Of course, the first electronic device or the second electronic device may compare the hardware configuration of the first electronic device with the hardware configuration of the second electronic device, and generate a trigger signal when it is determined that the target performance of the first electronic device is better than the target performance of the second electronic device based on the comparison result.

In some embodiments, after comparing the hardware configuration of the first electronic device with the hardware configuration of the second electronic device, a trigger signal may be generated if it is determined that the rendering performance of the first electronic device is better than the rendering performance of the second electronic device. The trigger signal may be sent to the first electronic device such that the GPU on the first electronic device can be shared subsequently based on the trigger signal to enhance the rendering performance.

In the sixth method, the trigger signal may be generated based on at least the space environment where the second electronic device is and/or the first electronic device are located.

In some embodiments, the space environment may include space noise and/or objects used within the space.

In the embodiments of the present disclosure, a trigger signal may be generated when the space environment where the first electronic device is located satisfies a first target space environment condition, or when the space environment where the second electronic device is located satisfies a second target space environment condition. Of course, the trigger signal may also be generated when the first electronic device satisfies the first target space environment condition and the second electronic device satisfies the second target space environment condition. In some embodiments, the first target space environment and the second target space environment may be the same or different.

In some embodiments, when the noise of the space where the second electronic device is located is greater than the target noise, a trigger signal may be generated and sent to the first electronic device. In some embodiments, the space environment may include space noise.

In some embodiments, a trigger signal may be generated when the user of the second electronic device is a target object, and the trigger signal may be sent to the first electronic device. In some embodiments, the usage object in the space may include the usage objects of the second electronic device.

In some embodiments, the number of usage objects of the second electronic device may be detected, and when it is determined that the number of usage objects is greater than a target number, a trigger signal may be generated. In some embodiments, the trigger signal may be generated by the first electronic device or the second electronic device.

In the seventh method, the trigger signal may be generated based on hardware usage of the second electronic device and/or the first electronic device.

In the embodiments of the present disclosure, the hardware usage of the first electronic device may be obtained, and when it is determined that the hardware usage of the hardware in the first electronic device satisfies a first target hardware usage, a trigger signal may be generated. The hardware usage of the second electronic device may also be obtained, and when it is determined that the hardware usage of the hardware in the second electronic device satisfies a second target hardware usage, a trigger signal may be generated. In addition, a trigger signal may be generated when the hardware usage of the hardware in the first electronic device satisfies the first target hardware usage, and the hardware usage of the hardware in the second electronic device satisfies the second target hardware usage. In some embodiments, the first target hardware usage and the second target hardware usage may be the same or different.

In some embodiments, the second electronic device may establish a communication connection with a plurality of third electronic devices. The second electronic device may receive to-be-processed images sent by the plurality of third electronic devices, and use its own GPU to process the to-be-processed images. At this time, the workload of the GPU of the second electronic device will increase, and when the usage of the GPU is greater than a preset target GPU usage, a trigger signal may be generated.

It should be noted that the target component may be determined based on the second hardware usage of the second electronic device, or the target component may be determined based on the first hardware usage of the first electronic device. In addition, the target component may also be determined based on the first hardware usage and/or the second hardware usage.

In some embodiments, when it is determined that the usage of the GPU in the second electronic device satisfies the target GPU usage, the GPU may be determined as the target component.

202, establishing a first connection channel between the target component and the second electronic device for the second electronic device to send first data to the target component or receive second data sent by the target component through the first connection channel.

In some embodiments, the first data and the second data may or may not have an association relationship. The first connection channel may be a connection channel through which the second electronic device can directly control or access the target component.

In the embodiments of the present disclosure, the target component may be directly connected to the second electronic device to establish the first connection channel between the target component and the second electronic device. Of course, considering the current power mode of the second electronic device, the first connection channel between the target component and the second electronic device may be established based on the current power mode of the second electronic device. In some embodiments, the target component may be used as an external component of the second electronic device to expand the performance of the second electronic device corresponding to the target component. In some embodiments, through the first connection channel, a target controller on the second electronic device may not participate int eh control when the target component provides services to the second electronic device.

In some embodiments, the target component may be the GPU on an AIO machine, the second electronic device may be a notebook computer, and the first connection channel between the GPU and the notebook computer may be established such that the notebook computer can directly control or access the GPU to use the GPU on the AIO machine to render the image output by the notebook computer to expand the rendering performance of the notebook computer.

In the embodiments of the present disclosure, the target component may be a processing unit. The second electronic device may send the first data to the processing unit on the first electronic device through the first connection channel. Subsequently, the processing unit may process the received first data to obtain the second data, and send the second data to the second electronic device through the first connection channel. In some embodiments, the first data and the second data may have an association relationship. In some embodiments, the processing unit may be a GPU, the first data may be a to-be-processed image, and the second data may be an image obtained after rendering the to-be-processed image.

In the embodiments of the present disclosure, the target component may also be a storage unit. The second electronic device may send the first data to the storage unit on the first electronic device through the first connection channel. The storage unit may store the received first data, and the storage unit may also receive an acquisition request sent by the second electronic device for obtaining the second data, and send the second data to the second electronic device through the first connection channel based on the acquisition request. In some embodiments, the first data and the second data may be the same data, and there may be an association relationship between the first data and the second data. Of course, the second data may also be data generated by the first electronic device itself, and there may be no association relationship between the first data and the second data.

It should be noted that establishing the first connection channel between the target component and the second electronic device in the process at 202 may be realized by: determining the current power mode of the first electronic device, and detecting paths between related components in the second electronic device based on the power mode to establish the first connection channel between a target interface and the target component, the target interface being an interface used by the first electronic device to establish a target connection with the second electronic device.

In some embodiments, the related components may be components on the path between the target interface and the target component in the current power mode of the first electronic device, and the power mode may be one of G3 mode, S0 mode, and S5 mode.

In the embodiments of the present disclosure, the first electronic device may detect the power mode it is in, and based on the power mode, when it is detected based on the power mode that there is no abnormality in the channel between the target interface and the target component, the first connection channel between the target interface and the target component may be established. Subsequently, the target connection may be established with the second electronic device through target interface such that the second electronic device can access or control the target component through the first connection channel.

203, establishing a second connection channel between the first electronic device and the second electronic device to receive a control instruction from the second electronic device for the target component, and perform a control action corresponding to the control instruction.

In the embodiments of the present disclosure, the first electronic device may be wired or wirelessly connected to the second electronic device to establish a second connection channel. When the first electronic device shares the target component with the second electronic device, the target controller of the second electronic device ma participates in the control. At this time, the second electronic device cannot directly control or access the target component, but can provide the control instruction to the target controller of the first electronic device. Based on the control instruction, the target controller may control the target component to provide the service to the second electronic device.

Consistent with the present disclosure, in response to the obtained trigger signal, the first electronic device may automatically use the determined target component corresponding to the trigger signal for the second electronic device to expand the performance of the target component corresponding to the second electronic device. For example, the second electronic device may use the target component on the first electronic device to process the target data without requiring the user to manually copy the target data on the second electronic device to the first electronic device. After the first electronic device processes the target data, processed target data does not need to be manually copied to the second electronic device, which reduces the operational complexity of processing the target data, thereby improving the processing of the target data.

FIG. 3 is a flowchart of another control method according to an embodiment of the present disclosure. The control method can be applied to the first electronic device. The method will be described in detail below.

301, in response to obtaining the trigger signal, determining the target component corresponding to the trigger signal.

It should be noted that the process at 306 may be performed after the process at 301.

302, determining the current power mode of the first electronic device.

It should be noted that any of the processes 303, 304, and 305 may be performed after the process at 302.

303, if the first electronic device is in a first power mode, outputting the current usage information of each related component to control the state of each related component after receiving a selection instruction to complete the path needed for establishing the first connection channel.

In some embodiments, the target interface may be an interface used by the first electronic device to establish a target connection with the second electronic device, and the first power mode may be the S0 mode. When the first electronic device is in the S0 mode, the first electronic device may be in a normal working state. The selection instruction may be an instruction to switch the target component to provide services for the second electronic device. The selection instruction may be generated by the first electronic device in response to the user's switching operation on the target component.

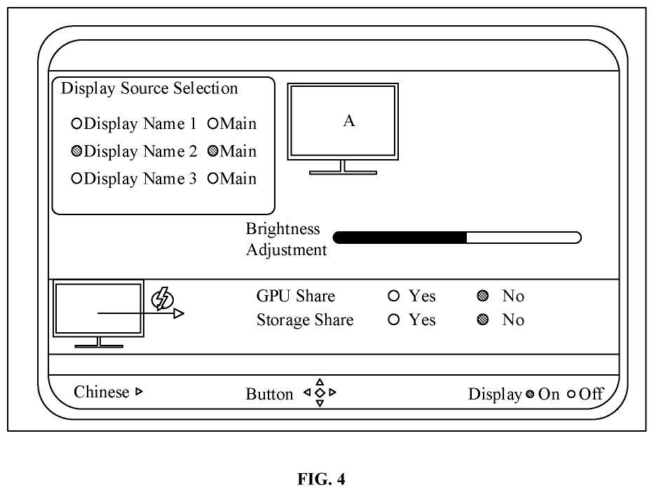

In some embodiments, as shown in FIG. 4, the user can input a switching operation for the target component on the target display interface of the first electronic device. In some embodiments, as shown in FIG. 3, the user selects storage sharing, the target component is the hard disk; when the user selects GPU sharing, the target component is the GPU.

In the embodiments of the present disclosure, when the first electronic device is in the S0 mode, each component in the first electronic device may be in the normal working state. The first electronic device may output the current usage information of the related components on the path between the target interface and the target component for the user to view. Subsequently, after receiving the selection instruction, the state of the related components may be controlled such that the first connection channel can be established when the related components are in a communication state.

It should be noted that when the first electronic device is in the first power mode, the first electronic device may determine whether it is needed to establish a connection channel and whether to provide the target component to the first electronic device for use. That is, whether to share the target component with the second electronic device can be selectively determined.

304, if the first electronic device is in a second power mode, outputting switching information of the target component and controlling the path between the target interface and the target component to complete the path needed to establish the first connection channel.

In some embodiments, the switching information may be information that the target component is switched from being used by the first electronic device to being used by the second electronic device. In some embodiments, the second power mode may be the S5 mode, and the first electronic device may be in a power-off state in the S5 mode.

In the embodiments of the present disclosure, when the first electronic device is in the S5 mode, switching information may be output to notify the user that the target component is in the mode of providing services to the second electronic device, and the path between the target interface and the target component may be controlled to be in the target connection state to complete the establishment of the first connection channel between the target interface and the target component.

It should be noted that when the first electronic device is in the second power mode, some power of the first electronic device will support some components to work. At this time, the first electronic device may not have the ability to selectively determine whether to share the target component with the second electronic device. However, the first electronic device is equipped with an output for notifying the user that the target component is switched from being used by the first electronic device to being used by the second electronic device.

305, if the first electronic device is in a third power mode, controlling the state of each related components between the target interface and the target component to complete the path needed to establish the first connection channel.

In some embodiments, the third power mode may be the G3 mode. When the first electronic device is in the G3 mode, the first electronic device may be in the power-off state.

In the embodiments of the present disclosure, when the first electronic device is in the G3 mode, the first electronic device itself may control the state of each related components between the target interface and the target component to be in the target state to complete the path needed to establish the first connection channel between the first connection channel and the target component.

It should be noted that when the first electronic device is in the third power mode, all components on the first electronic device may not be working. At this time, the first electronic device may not have the ability to selectively share the target component with the second electronic device. That is, when the first electronic device is connected to the second electronic device, the target component will be shared with the second electronic device.

The following describes in detail the establishment of the first connection channel between the target interface and the target component (e.g., a hard disk) when the first electronic device is respectively in the first power mode, the second power mode, and the third power mode in combination with an application scenario.

306, establishing a second connection channel between the first electronic device and the second electronic device to receive a control instruction from the second electronic device for the target component, and perform a control action corresponding to the control instruction.

Based on the foregoing embodiments, in other embodiments of the present disclosure, the control method may also include the following processes.

307, in response to obtaining event information that the target component exits the sharing state, determining the corresponding control logic based on the current power mode of the first electronic device to control the target component to be mounted to the target controller of the first electronic device.

In some embodiments, the sharing state may be a state in which the target component is shared for use by the second electronic device. In some embodiments, the event information may be an instruction/operation obtained on the first electronic device or the second electronic device to stop sharing the target component. The event information may be obtained when the target connection between the second electronic device and the first electronic device is disconnected.

In the embodiments of the present disclosure, the control logic corresponding to the current power mode of the first electronic device may be determined from a plurality of control logics pre-stored by the first electronic device for controlling the target component to be mounted on the target controller of the first electronic device. Based on the control logic corresponding to the current power mode of the first electronic device, the target component may be controlled to be mounted to the target controller of the first electronic device such that the target controller can control the target component to provide services to the first electronic device.

In some embodiments, the target controller may be a platform controller hub (PCH).

The following describes in detail the establishment of the first connection channel between the target interface and the target component (e.g., a hard disk), and the control of the target component to be mounted to the target controller of the first electronic device when the first electronic device is respectively in the first power mode, the second power mode, and the third power mode in combination with an application scenario.

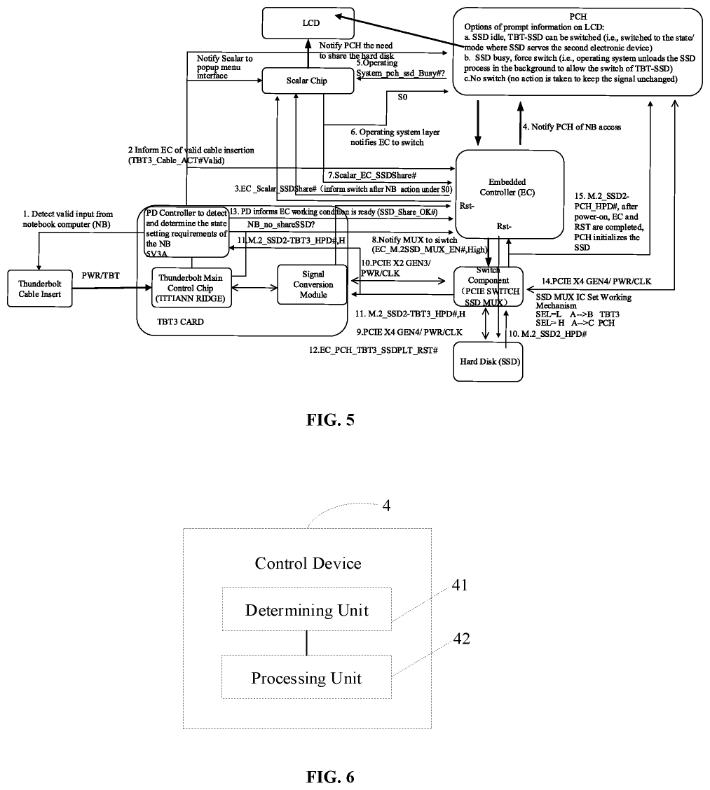

As shown in FIG. 5, the first electronic device is an AIO machine. The AIO machine includes Thunderbolt main control chip (Titan RIDGE), a proportional differential (PD) controller, a signal conversion module, an embedded controller (EC), a PCIe SWITCH SSD MUX (a switch component for switching hard disk services that support PCIe signals), a solid-state drive (SSD), a PCH, a Scalar chip, and a liquid crystal display (LCD). The signal conversion module may be used to convert the universal serial bus (USB) signal into a high-speed peripheral component interconnection express (PCIe) signal. The signal conversion module may also be referred to as the USB to PCIe bridge, and the PD controller may also be referred to as PD for short. The embedded controller may also be referred to as the EC controller. The Scalar chip may be configured to adjust the display color of the LCD, convert the signal output by the GPU into a signal that the LCD can display, and zoom the screen display.

When the first electronic device is in the S0 mode and a Thunderbolt cable is inserted into the Thunderbolt interface of the first electronic device, the process of determining the path between the Thunderbolt interface and the hard disk may be sequentially detecting 1→2→3→4→5→6→7→8→9→10→11→12→13, and responding to the finally realized hardware path. When the Thunderbolt cable is disconnected from the Thunderbolt interface, the first electronic device may perform 1→2→3 (scalar may prompt that the hard disk has stopped proving services for the notebook computer, and the SSD has returned to the AIO machine)→8→9→10→14→15→12 to complete the switching from SSD to PCH. Subsequently, the AIO machine may receive the switching instruction from the user to switch the SSD to provide services for the AIO machine through scalar's menu interface, and remount the SSD to PCH based on the switching instruction. In some embodiments, the process of mounting SSD to PCH may be 7→8→9→10→14→15→12.

When the first electronic device is in the S5 mode and a Thunderbolt cable is inserted into the Thunderbolt interface of the first electronic device, the process of determining the path between the Thunderbolt interface and the hard disk may be sequentially detecting 1→2→3→7→8→9→10→11→12→13, and responding to the finally realized hardware path. When the Thunderbolt cable is disconnected from the Thunderbolt interface, the first electronic device may perform 1→2→3 (scalar may prompt that the hard disk has stopped proving services for the notebook computer, and the SSD has returned to the AIO machine)→8→9→10→14→15→12 to complete the switching from SSD to PCH. Subsequently, the AIO machine may receive the switching instruction from the user to switch the SSD to provide services for the AIO machine through scalar's menu interface, and remount the SSD to PCH based on the switching instruction. In some embodiments, the process of mounting SSD to PCH may be 7→8→9→10→14→15→12.

When the first electronic device is in the G3 mode and a Thunderbolt cable is inserted into the Thunderbolt interface of the first electronic device, the process of determining the path between the Thunderbolt interface and the hard disk may be sequentially detecting 1→2→8→9→10→11→12, and responding to the finally realized hardware path. When the Thunderbolt cable is disconnected from the Thunderbolt interface, the first electronic device may perform 1→2→8→9→10→14→15 to realize switching from SSD to PCH.

It should be noted that when the signal received by Titan Ridge is a USB signal, the USB signal may be converted into a PCIe signal, and the PCIe signal may be sent to the PEIC SWITCH SSD MUX.

308, in response to obtaining the connection request from the second electronic device, outputting a prompt for target authentication.

In the embodiments of the present disclosure, when the first electronic device receives the connection request sent by the second electronic device, the first electronic device may obtain authentication information to perform target authentication on whether the second electronic device can access the first electronic device based on the authentication information and output a prompt for target authentication to notify the user that target authentication is currently in progress. In some embodiments, the authentication information may be information entered by the user on the first electronic device, the authentication information may also be sent to the first electronic device after the user inputs the authentication information on the second electronic device, or it may be obtained by the first electronic device from a third-party device.

It should be noted that target authentication may be performed on the first electronic device, the second electronic device, or the third-party device. In some embodiments, the third-party device may be an intermediate device between the first electronic device and the second electronic device. While outputting the target authentication prompt, the user may also be required to input the access account and access password for the second electronic device to access the target component. When the first electronic device determines that the access account and the access password match, the protection of the target component by the bitlocker of the operating system may be removed.

309, if the second electronic device passes the target authentication, establishing a target connection and/or configuring usage permission for the target component.

In the embodiments of the present disclosure, the authentication information may be matched with the authentication information in an authentication whitelist. If the authentication information matches the authentication information in the authentication whitelist, it can be determined that the second electronic device has passed the target authentication, and the target connection can be established at this time. In addition, the usage permission of the second electronic device to the target component may also be configured such that the second electronic device can use the target component to process its own business data.

310, if the second electronic device fails the target authentication, modifying the access permission of the second electronic device and/or the usage permission of the target component.

In the embodiments of the present disclosure, if the target authentication fails, if the authentication information does not match the authentication information in the authentication whitelist, it can be determined that the target authentication has not been passed, and the first identification information of the second electronic device may be added to an authentication blacklist to realize the modification of the access permission of the second electronic device such that the second electronic device cannot access the first electronic device in the future. Alternatively, the second identification information of the second electronic device may also be added to the usage permission blacklist of the target component to deny the second electronic device access to the target component.

It should be noted that, for descriptions of the same processes and content in this embodiment as in other embodiments, reference can be made to the descriptions in other embodiments, and details will not be repeated here.

Consistent with the present disclosure, in response to the obtained trigger signal, the first electronic device may automatically use the determined target component corresponding to the trigger signal for the second electronic device to expand the performance of the target component corresponding to the second electronic device. For example, the second electronic device may use the target component on the first electronic device to process the target data without requiring the user to manually copy the target data on the second electronic device to the first electronic device. After the first electronic device processes the target data, processed target data does not need to be manually copied to the second electronic device, which reduces the operational complexity of processing the target data, thereby improving the processing of the target data.

Based on the foregoing embodiments, an embodiment of the present disclosure provides a control device. The control device can be applied to the control method provided by the embodiments corresponding to FIGS. 1-3. FIG. 6 is a schematic structural diagram of a control device according to an embodiment of the present disclosure. As shown in FIG. 6, the control device 4 includes a determining unit 41 and a processing unit 42. The determining unit may be configured to respond to an obtained signal, and determine a target component corresponding to the trigger signal. The processing unit may be configured to share the target component with the second electronic device to expand the performance of the second electronic device corresponding to the target component. In some embodiments, the second electronic device may be a device that establishes a target connection with the control device.

In some embodiments, the sharing method of the target component may be different when the control device is in different power mode.

In some embodiments, the trigger signal may be generated based on: an input operation acting on the first electronic device, an input operation acting on the second electronic device, the establishment of a target connection between the second electronic device and the first electronic device, the target application running on the second electronic device, at least the hardware configuration information of the second electronic device, at least on the space environment where the second electronic device and/or the first electronic device is located, and the hardware usage of the second electronic device and/or the first electronic device.

In some embodiments, the determining unit 41 may be configured to determine the component that matches the first identification information among the components that can be shared by the first electronic device as the target component if the trigger signal carries the first identification information that can point to the target component; determine the power mode of the first electronic device, and determine the target component from the components that can be shared by the first electronic device based on the power mode; determine the power mode of the first electronic device and the component usage parameters of each component of the first electronic device in the power mode, and determine the target component based on the power mode and the component usage parameters; obtain the second identification information of the second electronic device, and determine the component in the first electronic device that matches the second identification information as the target component; and obtain the generation time of the trigger signal, and determine the component in the first electronic device that matches the generation time as the target component.

In some embodiments, the processing unit 42 may be configured to establish a first connection channel between the target component and the second electronic device for the second electronic device to send first data to the target component or receive second data sent by the target component through the first connection channel, the first data may or may not have an association relationship with the second data; and establish a second connection channel between the first electronic device and the second electronic device to receive a control instruction from the second electronic device for the target component, and perform a control action corresponding to the control instruction.

In some embodiments, the processing unit 42 may be configured to determine the current power mode of the first electronic device, and detect paths between related components in the second electronic device based on the power mode to establish the first connection channel between a target interface and the target component, the target interface being an interface used by the first electronic device to establish a target connection with the second electronic device

In some embodiments, the processing unit 42 may be configured to, if the first electronic device is in the first power mode, output the current usage information of each component to control the state of each related components after receiving the selection instruction to complete the path needed for establishing the first connection channel; if the first electronic device is in the second power mode, output the switching information of the target component and control the path between the target interface and the target component to complete the path needed for establishing the first connection channel, the switching information being information that the target component is switched from being used by the first electronic device to being used by the second electronic device; and, if the first electronic device is in the third power mode, control the state of each related component between the target interface and the target component to complete the path needed for establishing the first connection channel.

In some embodiments, the processing unit 42 may be configured to, in response to obtaining the event information that the target component has exited the shard state, determine the corresponding control logic based on the current power mode of the first electronic device to control the target component to be mounted to the target controller of the first electronic device, the sharing state being a state in which the target component is shared for use by the second electronic device.

In some embodiments, the processing unit 42 may be configured to output a prompt for target authentication in response to obtaining a connection request from the second electronic device; and, establish a target connection and/or configure usage permission for the target component if the second electronic device passes the target authentication; or, modify the access permission of the second electronic device and/or the usage permission of the target component if the second electronic device fails the target authentication.

It should be noted that, for the interaction process between the units in the embodiments of the present disclosure, reference can be made to the implementation process in the control method provided by the embodiments corresponding to FIGS. 1-3, which will not be repeated here.

Consistent with the present disclosure, in response to the obtained trigger signal, the first electronic device may automatically use the determined target component corresponding to the trigger signal for the second electronic device to expand the performance of the target component corresponding to the second electronic device. For example, the second electronic device may use the target component on the first electronic device to process the target data without requiring the user to manually copy the target data on the second electronic device to the first electronic device. After the first electronic device processes the target data, processed target data does not need to be manually copied to the second electronic device, which reduces the operational complexity of processing the target data.

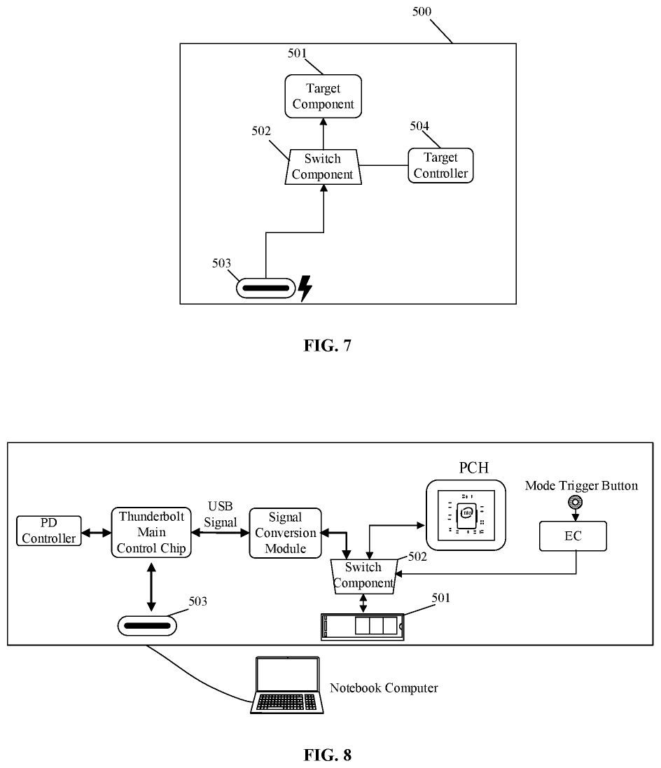

Based on the foregoing embodiments, an embodiment of the present disclosure provides an electronic device, which can be applied to the control method provided by the embodiments corresponding to FIGS. 1-3 when it is used as the first electronic device. FIG. 7 is a schematic structural diagram of an electronic device 500 according to an embodiment of the present disclosure. As shown in FIG. 7, the electronic device 500 includes a target component 501, a switch component 502, a third end of the switch component 502 may be connected to the target component 501, a target interface 503, and the target controller 504. The target component 501 may be configured to provide a target function. The target interface 503 may be configured to establish a target connection with the second electronic device (not shown in FIG. 7). The output end of the target controller 504 may be connected to a first end of the switch component 502. The target controller 504 may be configured to control a second end of the switch component 502 to be connected to the target interface 503, and to control the path between the switch component 502 and the target interface 503 to share the target component 501 with the second electronic device to expand the performance of the target component corresponding to the second electronic device.

In some embodiments, the target interface may be a Thunderbolt interface, the target controller ma be an EC, the switch component may be a PCIe switch, the target component may be a hard disk or a GPU. Of course, the target component may also be other components, which is not limited in the embodiments of the present disclosure.

In the embodiments of the present disclosure, the first electronic device may establish a target connection with the second electronic device through the target interface. Subsequently, the target controller may receive a switching instruction triggered by the user, and control the second end of the switch component to be connected to the target component based on the switching instruction. The first electronic device may establish a first connection channel between the target component and the second electronic device such that the second electronic device can send the first data to the target component or receive the second data sent by the target component through the first connection channel. Of course, the first electronic device may also establish a second connection channel between the first electronic device and the second electronic device, to receive a control instruction from the second electronic device for the target component, and perform a control action corresponding to the control instruction. In some embodiments, the switching instruction may be for switching the state of the target component serving the first electronic device to the state or mode of the target component serving the second electronic device.

FIG. 8 is a schematic structural diagram of another electronic device according to an embodiment of the present disclosure. As shown in FIG. 8, the switch component can be a PCIe MUX, the target component can be a hard disk, and the target controller can include EC, PCH, PD controller, Titan Ridge, and scalar (not shown in FIG. 8).

In the embodiments of the present disclosure, when the PD controller determines that a notebook computer is connected to the electronic device, the PD controller may transmit the signal detected by the notebook computer to the EC. The EC may control the PCIe MUX (e.g., the switch component) to disconnect from the PCH, and the EC may control the PCIe MUX (e.g., the switch component) to connect to the Titan Ridge (e.g., the Thunderbolt main control chip). In some embodiments, the PCH may be a controller for maintaining the hard disk to provide services for the first electronic device, and the EC may be a controller for controlling the switching of the PCIe MUX. When the EC controls the connection between the PCIe MUX and the Titan Ridge, the first electronic device may send a control signal to the Titan Ridge, and the Titan Ridge may forward the control signal to the hard disk, thereby realizing the control of the hard disk by the second electronic device.

In some embodiments, the EC may include a mode trigger button. When the user presses the mode trigger button, the EC may generate a switching instruction based on the mode trigger button, and switch the hard disk to a target mode for providing services to the notebook computer based on the switching instruction.

It should be noted that, as shown in FIG. 8, the electronic device also includes a USB to PCIe bridge (e.g., the signal conversion module). When the USB to PCIe bridge receives the signal transmitted by the Titan Ridge as a USB signal, the USB to PCIe bridge may convert the USB signal into a PCIe signal, and then transmit the PCIe signal to the hard disk to control the hard disk. When the signal receives by the USB to PCIe bridge is a PCIe signal, the USB to PCIe bridge may directly forward the PCIe signal to the hard disk to realize the control of the hard disk.

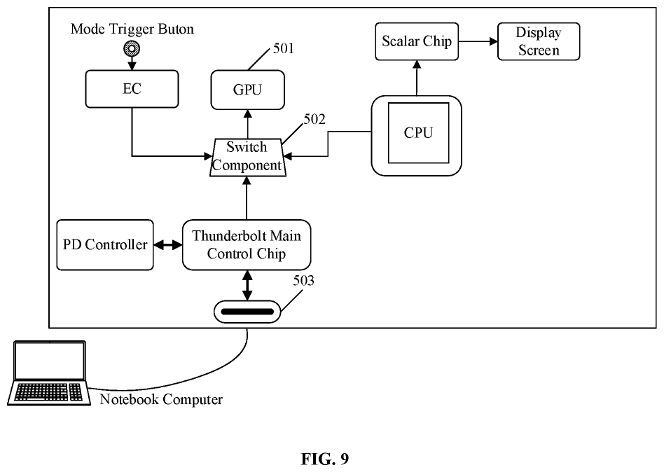

FIG. 9 is a schematic structural diagram of another electronic device according to an embodiment of the present disclosure. As shown in FIG. 9, the target component can be a GPU, and the target controller can also include an EC, a CPU, a PD controller, a Titan Bridge, and a scalar chip.

In the embodiments of the present disclosure, the PD controller may detect when a notebook computer is connected to an electronic device, and transmit the detected signal transmitted by the notebook computer to the EC. The EC may control the PCIe MUX to disconnect from the CPU, and the EC may control the PCIe MUX to connect to the Titan Ridge such that the Titan Ridge can receive the control signal transmitted by the notebook computer through eh target interface and transmit the control signal to the GPU to realize the control or access of the notebook computer to the GPU. Subsequently, the GPU can process the to-be-processed image transmitted by the notebook computer.

In some embodiments, when the PCIe MUX is connected to the CPU, the GPU may receive the to-be-processed image transmitted by the CPU to process the to-be-processed image, and transmit the processed to-be-processed image to the CPU. The CPU may transmit the processed to-be-processed image to the scalar chip, and the display the processed to-be-processed image on the display screen connected to the scalar chip.

Consistent with the present disclosure, the electronic device may include a target component, a switch component, a target interface, and the target controller. The target component may be configured to provide a target function. The third end of the switch component may be connected with the target component. The target interface may be configured to establish a target connection with the second electronic device. The output end of the target controller may be connected to the first end of the switch component. The target controller may be configured to control the connection between the second end of the switch component and the target interface, and to control the path between the switch component and the target interface to share the target component with the second electronic device to expand the performance of the target component corresponding to the second electronic device. In this way, the target connection between the first electronic device and the second electronic device can be established via the target interface on the first electronic device. Subsequently, the first electronic device may establish the first connection channel or the second connection channel for sharing the target component with the second electronic device such that the subsequent second electronic device may access or control the target component based on the first connection channel or the second connection channel.

Based on the foregoing embodiments, embodiments of the present disclosure provide a computer-readable storage medium. The computer-readable storage medium may store one or more programs. The one or more programs may be executed by one or more processors to realize the processes of the control methods provided by embodiments corresponding to FIGS. 1-3.

In some embodiments, the above-described computer-readable storage medium may include a read-only memory (ROM), a programmable read-only memory (PROM), an erasable programmable read-only memory (EPROM), an electrically erasable programmable read-only memory (EEPROM), a ferromagnetic random-access memory (FRAM), a flash memory, a magnetic surface memory, a CD, or a compact disc read-only memory (CD-ROM), etc. The above computer-readable storage medium may further include a variety of electronic apparatuses including one or any combination of the above-described memories, such as mobile phones, computers, tablet devices, and personal digital assistants, etc.

In some embodiments, the terms “include”, “contain” or any other variants thereof are intended to cover non-exclusive inclusion, such that a process, a method, an article or a device including a series of elements not only includes those elements, but also includes other elements not explicitly listed, or elements inherent to the process, the method, the article, or the device. Without more restrictions, the element defined by the sentence “including a . . . ” does not exclude the existence of other identical elements in the process, the method, the article, or the device that includes the element.

The numbers of the above embodiments of the present disclosure are for description only and do not represent the advantages and disadvantages of the embodiments.

Through the description of the above embodiments, those skilled in the art may clearly understand that the method of the above embodiments may be implemented by means of software plus necessary general hardware nodes. The method may also be implemented by hardware, but in many cases, the former is a better implementation manner. The technical solution of this application essentially or the part that contributes to the existing technology can be embodied in the form of a software product, and the computer software product stored in a storage medium (such as ROM/RAM, magnetic disk, optical disc) includes several instructions to enable a terminal device (such as the mobile phone, the computer, the server, an air conditioner, or a network device, etc.) to execute the methods described in the various embodiments of the present disclosure.

Embodiments of the present disclosure are described regarding flowcharts and/or block diagrams of methods, devices (systems), and computer program products. In some embodiment, each process and/or block of the flowchart and/or block diagram, and the combination of processes and/or blocks in the flowchart and/or block diagram may be implemented by computer program instructions. The computer program instruction is provided to the processor of a general-purpose computer, a special-purpose computer, an embedded processor, or other programmable data processing equipment to produce a machine, so that the instructions executed by the processor of the computer or other programmable data processing equipment are configured for implementing the functions specified in one flow or a plurality of flows in the flowchart and/or one block or multiple blocks in the block diagram.

The computer program instructions may also be stored in a computer-readable memory that can direct a computer or other programmable data processing equipment to work in a specific manner so that the instructions stored in the computer-readable memory produce an article of manufacture including the instruction device. The device implements the functions specified in one process or multiple processes in the flowchart and/or one block or multiple blocks in the block diagram.

These computer program instructions may also be loaded on a computer or other programmable data processing equipment, so that a series of operation processes are executed on the computer or other programmable equipment to produce computer-implemented processing, so as to execute on the computer or other programmable equipment. The instructions provide steps for implementing the functions specified in one process or multiple processes in the flowchart and/or one block or multiple blocks in the block diagram.

The above are only preferred embodiments of the present disclosure and do not limit the scope of this application. Any equivalent structure or equivalent process transformation made using the content of the description and drawings of the disclosure, or directly or indirectly used in other related technical fields are also included in the scope of patent protection of the present disclosure.

What is claimed is:

1. A control method applied to a first electronic device comprising:
in response to obtaining a trigger signal, determining a target component corresponding to the trigger signal; and
providing the target component to a second electronic device for use to expand performance of the second electronic device corresponding to the target component, the second electronic device being a device that establishes a target connection with the first electronic device, wherein:
when the first electronic device is in a different power mode, a sharing method of the target component is different.

2. The control method of claim 1, wherein the trigger signal is generated based on at least one of:
an input operation acting on the first electronic device;
an input operation acting on the second electronic device;
an establishment of the target connection between the second electronic device and the first electronic device;
a target application running on the second electronic device;
at least hardware configuration information of the second electronic device;
at least space environment where the second electronic device and/or the first electronic device are located; and
hardware usage of the second electronic device and/or the first electronic device.

3. The control method of claim 1, wherein determining the target component corresponding to the trigger signal includes at least one of:
if the trigger signal carries first identification information to point to the target component, determining the component that matches the first identification information among the components shared by the first electronic device as the target component;
determining the power mode of the first electronic device, and determining the target component from components shared by the first electronic device based on the power mode;
determining the power mode of the target component and a component usage parameter of each component of the first electronic device in the power mode, and determining the target component based on the power mode and the component usage parameter;
obtaining second identification information of the second electronic device, and determining a component in the first electronic device that matches the second identification information as the target component; and
obtaining generation time of the trigger signal, and determining a component in the first electronic device that matches the generation time as the target component.

4. The control method of claim 1, wherein sharing the target component to the second electronic device includes at least one of:
establishing a first connection channel between the target component and the second electronic device for the second electronic device to send first data to the target component or receive second data sent by the target component through the first connection channel, the first data having or not having an association relationship with the second data; and
establishing a second connection channel between the first electronic device and the second electronic device to receive a control instruction from the second electronic device for the target component, and performing a control action corresponding to the control instruction.

5. The control method of claim 4, wherein establishing the first connection channel between the target component and the second electronic device includes:
determining the current power mode of the first electronic device, and detecting a path between related components in the first electronic device based on the power mode to establish the first connection channel between a target interface and the target component, the target interface being an interface used by the first electronic device to establish the target connection with the second electronic device.

6. The control method of claim 5, wherein detecting the path between the related components in the first electronic device based on the power mode includes:
if the first electronic device is in a first power mode, outputting current usage information of each related components to control state of each related component after receiving a selection instruction to complete the path needed for establishing the first connection channel;
if the first electronic device is in a second power mode, outputting switching information of the target component, and controlling the path between the target interface and the target component to complete the path needed for establishing the first connection channel, the switching information being information that the target component is switched from being used by the first electronic device to being used by the second electronic device; and
if the first electronic device is in a third power mode, controlling the state of each related component between the target interface and the target component to complete the path needed for establishing the first connection channel.

7. The control method of claim 5 further comprising:
in response to obtaining event information that the target component has exited a sharing state, determining a corresponding control logic based on the current power mode of the first electronic device to control the target component to be mounted to a target controller of the first electronic device, the sharing state being a state shared by the target component for use by the second electronic device.

8. The control method of claim 1 further comprising:
in response to obtaining a connection request from the second electronic device, outputting a prompt for target authentication; and
if the second electronic device passes the target authentication, establishing the target connection and/or configuring usage permission of the target component; or,
if the second electronic device fails the target authentication, modifying access permission of the second electronic device and/or the usage permission of the target component.

9. A control device comprising:
a determining unit, the determining unit being configured to, in response to obtaining a trigger signal, determine a target component corresponding to the trigger signal; and
a processing unit, the processing unit being configured to provide the target component to a second electronic device for use to expand performance of the second electronic device corresponding to the target component, the second electronic device being a device for establishing a target connection with the control device, wherein:
when the control electronic device is in a different power mode, a sharing method of the target component is different.

10. The control device of claim 9, wherein the trigger signal is generated based on at least one of:
an input operation acting on a first electronic device;
an input operation acting on the second electronic device;
an establishment of the target connection between the second electronic device and the first electronic device;
a target application running on the second electronic device;
at least hardware configuration information of the second electronic device;
at least space environment where the second electronic device and/or the first electronic device are located; and
hardware usage of the second electronic device and/or the first electronic device.

11. The control device of claim 9, wherein the determining unit is further configured to:
if the trigger signal carries first identification information to point to the target component, determine the component that matches the first identification information among the components shared by the first electronic device as the target component;
determine the power mode of the first electronic device, and determine the target component from components shared by the first electronic device based on the power mode;
determine the power mode of the target component and a component usage parameter of each component of the first electronic device in the power mode, and determine the target component based on the power mode and the component usage parameter;
obtain second identification information of the second electronic device, and determine a component in the first electronic device that matches the second identification information as the target component; and
obtain generation time of the trigger signal, and determining a component in the first electronic device that matches the generation time as the target component.

12. The control device of claim 9, wherein the processing unit is further configured to:
establish a first connection channel between the target component and the second electronic device for the second electronic device to send first data to the target component or receive second data sent by the target component through first connection channel, the first data having or not having an association relationship with the second data; and
establish a second connection channel between the first electronic device and the second electronic device to receive a control instruction from the second electronic device for the target component, and perform a control action corresponding to the control instruction.

13. The control device of claim 12, wherein the processing unit is further configured to:
determine the current power mode of the first electronic device, and detect a path between related components in the first electronic device based on the power mode to establish the first connection channel between a target interface and the target component, the target interface being an interface used by the first electronic device to establish the target connection with the second electronic device.

14. The control device of claim 13, wherein the processing unit is further configured to:
if the first electronic device is in a first power mode, output current usage information of each related components to control state of each related component after receiving a selection instruction to complete the path needed for establishing the first connection channel;
if the first electronic device is in a second power mode, output switching information of the target component, and control the path between the target interface and the target component to complete the path needed for establishing the first connection channel, the switching information being information that the target component is switched from being used by the first electronic device to being used by the second electronic device; and
if the first electronic device is in a third power mode, control thee state of each related component between the target interface and the target component to complete the path needed for establishing the first connection channel.

15. The control device of claim 13, wherein the processing unit is further configured to:
in response to obtaining event information that the target component has exited a sharing state, determine a corresponding control logic based on the current power mode of the first electronic device to control the target component to be mounted to a target controller of the first electronic device, the sharing state being a state shared by the target component for use by the second electronic device.

16. The control device of claim 9, wherein the processing unit is further configured to:
in response to obtaining a connection request from the second electronic device, output a prompt for target authentication; and
if the second electronic device passes the target authentication, establish the target connection and/or configure usage permission of the target component; or,
if the second electronic device fails the target authentication, modify access permission of the second electronic device and/or the usage permission of the target component.

17. An electronic device, the electronic device being used as a first electronic device, comprising:
a target component, the target component being configured to provide a target function;
a switch component, a third end of the switch component being connected to the target component;
a target interface, the target interface being configured to establish a target connection with a second electronic device; and
a target controller, an output end of the target controller being connected to a first end of the switch component, the target controller being configured to control a second end of the switch component to be connected to the target interface, and to control a path between the switch component and the target interface to share the target component with the second electronic device to expand performance of the target component corresponding to the second electronic device.

18. The electronic device of claim 17, wherein the trigger signal is generated based on at least one of:
an input operation acting on a first electronic device;
an input operation acting on the second electronic device;
an establishment of the target connection between the second electronic device and the first electronic device;
a target application running on the second electronic device;
at least hardware configuration information of the second electronic device;
at least space environment where the second electronic device and/or the first electronic device are located; and
hardware usage of the second electronic device and/or the first electronic device.

19. The electronic device of claim 17, wherein the target controller is further configured to:
if the trigger signal carries first identification information to point to the target component, determine the component that matches the first identification information among the components shared by the first electronic device as the target component;
determine the power mode of the first electronic device, and determine the target component from components shared by the first electronic device based on the power mode;
determine the power mode of the target component and a component usage parameter of each component of the first electronic device in the power mode, and determine the target component based on the power mode and the component usage parameter;
obtain second identification information of the second electronic device, and determine a component in the first electronic device that matches the second identification information as the target component; and
obtain generation time of the trigger signal, and determining a component in the first electronic device that matches the generation time as the target component.

20. The electronic device of claim 17, wherein the target interface is further configured to:
establish a first connection channel between the target component and the second electronic device for the second electronic device to send first data to the target component or receive second data sent by the target component through first connection channel, the first data having or not having an association relationship with the second data; and
establish a second connection channel between the first electronic device and the second electronic device to receive a control instruction from the second electronic device for the target component, and perform a control action corresponding to the control instruction.
